(19) United States
(12) Patent Application Publication
(10) Pub. No.: US 2002/0158809 A1
(43) Pub. Date: Oct. 31, 2002

(54) Excellent waterproof antenna

(75) Inventors: Tadaaki Onishi, Fukushima-ken (JP); Hirotoshi Maegawa, Nara-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/131,897

(22) Filed: Apr. 25, 2002

(30) Foreign Application Priority Data
Apr. 25, 2001 (JP) 2001-127586

(51) Int. Cl. H01Q 1/42

(52) U.S. Cl. 343/872; 343/700 MS

(57) ABSTRACT

In the waterproof structure of an antenna of the present invention, a width of an open end top of a second notch provided on a projection of a second case is formed so as to be wider than a diameter of a cable, the cable that crosses a recess of a first case is placed in a first notch, and the projection that projects into the recess allows an adhesive to penetrate in the second notch and the adhesive seals a space between the cable and the second notch to thereby seal containers. As the result, a space between a top half of the cable and the second notch is sealed securely with the adhesive, the containers are sealed securely, and reliable waterproof is realized.

### BACKGROUND OF THE INVENTION

1. Field of the Invention

This invention relates to a waterproof structure of an antenna used favorably for GPS (global positioning system) receiving antennas that are mounted on the outdoor of moving objects such as ships and automobiles.

2. Description of the Related Art

The conventional waterproof structure of an antenna will be described with reference to FIG. 10 to FIG. 13. A first case 51 comprising a mold product consisting of synthetic resin that is served as an under case is provided with a flat plate bottom wall 51a, two ring projection walls 51b that are different in diameter and project upward from the bottom wall 51a, a circular ring recess 51c formed between the two projection walls 51b, and a pair of first notches 51d formed on the two projection walls 51b so as to be positioned opposingly each other with interposition of the recess 51c.

Furthermore, the first case 51 comprises an arc recess holder 51e formed at the position so as to oppose to the first notch 51d, a plurality of mounting holes 51f formed on the bottom wall 51a, and a recess container 51g positioned at the center of the projection walls 51b.

An adhesive 52 is filled in the recess 51c and contained in the recess 51c.

An antenna 53 comprises an antenna body 54 and a coaxial cable 58, and the antenna body 54 comprises a rectangular parallelepiped antenna 55, a printed board 56 having a wiring pattern (not shown in the drawing) for attaching the antenna 55, and a box shield member 57 formed of a metal plate mounted on the printed board 56.

Furthermore, the circular cable 58 comprises a sheath 60 for sheathing a core wire 59 consisting of insulating material such as rubber, and a winding 61 that is wound partially on the sheath 60 consisting of insulating material, and the core wire 59 of the cable 58 is connected to the wiring pattern of the printed board 56 by means of soldering.

The antenna body 54 of the antenna 53 having the structure as described hereinabove is contained in the container 51g, the cable 58 is placed in the first notch 51d so as to cross the recess 51c, and the winding 61 is positioned on the holder 51e.

The width of the first notch 51d is formed so as to be approximately equal to the diameter of the cable 58. As the result, when the cable 58 is inserted into the first notch 51d, the sheath 60 of the cable 58 is inserted into with pressure and tightly compressed on the inside of the first notch 51d and the sheath 60 of the cable 58 is in tight contact with the bottom of the first notch 51d.

Furthermore, when the cable 58 has inserted with pressure into the first notch 51d, the bottom of the cable 58 is positioned in the adhesive 52 contained in the recess 51c, and around the bottom half of the cable 58, the space between the first notch 51d and the cable 58 is sealed with the adhesive 52 and the bottom half of the cable 58 is sealed by pressing the sheath 60 of the cable 58 with pressure on the inside wall of the first notch 51d. Thereby, the container 51g is sealed on the lead-out side of the cable 58 of the first case 51 side.

A second case 62 comprising a mold product consisting of synthetic resin that is served as a upper case comprises a bowl-shaped top wall 62a having the same peripheral configuration as that of the bottom wall 51a, a circular ring projection 62b that projects downward from the top wall 62a, a second notch 62c formed on the projection 62b having the same width as that of the first notch 51d that is positioned so as to oppose to the first notch 51d, a circular recess holder 62d formed at the position so as to oppose to the second notch 62c, a plurality of mounting holes 62e formed on the top wall 62a at the positions opposing to the mounting holes 51f, and a recess container 62f positioned at the center of the projection 62b.

The second case 62 is fitted combinedly to the first case 51 so as to cover over the antenna body 54, and a plurality of screws 63 are inserted and screwed from the mounting holes 51f side of the first case 51 into the mounting holes 62e of the second case 62 to thereby combine the first case 51 to the second case 62.

When the first and second cases 51 and 62 are combined, the winding 61 of the sheath 60 of the cable 58 is held with the holders 51e and 62d, the projection 62b is inserted into the recess 51c, and the top end of the projection 62b is embedded into the adhesive 52.

Furthermore, at that time, the cable 58 is positioned in the second notch 62c, the top of the second notch 62c presses the sheath 60 onto the first notch 51d side, the sheath 60 is inserted with pressure into and tightly pressed on the inside wall of the second notch 62. Thereby, the container 62f is sealed on the lead-out side of the cable 58 of the second case 62 side.

In other words, on the lead-out side of the cable 58 of the first and second cases 51 and 62, by inserting with pressure into and tightly pressing the cable 58 on the first and second notches 51d and 62c, the containers 51g and 62f are sealed, and by embedding the projection 62b in the adhesive 52, the surrounding of the container 51g and 62f is sealed. As the result, the antenna body 54 is waterproofed.

Next, a method for combining the first and second cases 51 and 62 will be described with reference to FIG. 13. As shown in FIG. 13, the second case 62 covers the first case 51 so that the second notch 62c is fitted to the cable 58 in the state that the cable 58 has been inserted with pressure into the first notch 51d of the first case 51.

As the result, at first, the inside wall that is opposing to the second notch 62c is brought into contact with the sheath 60, and when the second case 62 is moved downward further in this state, the top end of the projection 62b is embedded in the adhesive 52.

The surface of the adhesive 52 moves upward concomitantly with embedding of the projection 62b, the top of the second notch 62c presses the sheath 60 of the cable 58, the sheath 60 is pressed on the bottom of the first notch 51d, and the combination of the first and second cases 51 and 62 is completed.

However, though the surface of the adhesive 52 moves upward concomitantly with embedding of the projection 62b when these cases 51 and 62 are combined, because the width of the second notch 62c is formed so as to be approximately equal to the diameter of the cable 58, there is no space between the second notch 62c and the top open portion of the cable 58. As the result, the adhesive 52 does not penetrate into the space between the second notch 62c and the cable 58 though the surface of the adhesive moves upward, and no penetration of the adhesive 52 results in poor sealing between the second notch 62c and the cable 58 and results in poor waterproof of the containers 51g and 62f.

In particular, variation of contact tightness between the second notch 62c and the cable 52 due to variation of the width of the second notch 62c caused when the second case 62 is fabricated or variation of the diameter of the cable 58 or a slight space between the second notch 62c and the cable 52 results in poor sealing and further results in poor waterproof of the containers 51g and 62f.

There is no space between the second notch 62c and the open end top of the cable 58 because the width of the second notch 62c is formed so as to be approximately equal to the diameter of the cable 58 in the case of the waterproof structure of the conventional antenna. As the result, the adhesive 52 does not penetrate into the space between the second notch 62c and the cable 58, and no penetration of the adhesive 52 results in poor sealing between the second notch 62c and the cable 58 and results in poor waterproof of the containers 51g and 62f.

In particular, variation of contact tightness between the second notch 62c and the cable 52 due to variation of the width of the second notch 62c caused when the second case 62 is fabricated or variation of the diameter of the cable 58 or a slight space between the second notch 62c and the cable 52 results in poor sealing and further results in poor waterproof of the containers 51g and 62f. The poor waterproof causes a problem.

### SUMMARY OF THE INVENTION

In view of the above, the object of the present invention is to provide an inexpensive reliable waterproof structure of an antenna.

To solve the abovementioned problem, the first solution means has the structure provided with first and second cases, an antenna body contained in containers comprising the first and second cases, and a cable that is lead to the outside of the first and second cases, wherein the first cases has a recess for containing adhesive and a first notch for placing the cable that is disposed so as to cross the recess, the second case has a projection that projects into the recess and a second notch disposed on the projection that is positioned so as to oppose to the first notch for positioning the cable, a width of an open end top of the second notch is formed so as to be wider than a diameter of the cable, the cable that crosses the recess is placed in the first notch, and the projection that projects into the recess allows the adhesive to penetrate into the second notch to thereby seal a space between the cable and the second notch and to thereby seal the containers.

The second solution means has the structure in which a width of the first notch is formed so as to be approximately equal to the diameter of the cable.

Furthermore, the third solution means has the structure in which the recess is formed in ring-shape, the projection is formed in ring-shape, a top end of the projection excepting a portion positioned at the second notch is embedded in the adhesive and the containers are sealed thereby.

Furthermore, the fourth solution means has the structure in which the cable is positioned at a top of the second notch, and the space between the second notch including the top and the cable is sealed with the adhesive.

Furthermore, the fifth solution means has the structure in which the second notch is provided with an inclination formed so that a width of the second notch becomes wider from the top toward the open end top.

### BRIEF DESCRIPTION OF THE DRAWINGS

FIG. 1 is a plan view showing the waterproof structure of an antenna in accordance with the present invention.

FIG. 2 is a partial cross sectional view along the line 2-2 of FIG. 1.

FIG. 3 is a plan view showing the waterproof structure of the antenna of the present invention from which a second case is removed.

FIG. 4 is a partial cross sectional view along the line 4-4 of FIG. 2.

FIG. 5 is a plan view of a first case in accordance with the waterproof structure of the antenna of the present invention.

FIG. 6 is a partial cross sectional view along the line 6-6 of FIG. 5.

FIG. 7 is a bottom view of the second case in accordance with the waterproof structure of the antenna of the present invention.

FIG. 8 is a partial cross sectional view along the line 8-8 of FIG. 7.

FIG. 9 is an explanatory diagram showing a combination of the first and second cases in accordance with the waterproof structure of the antenna of the present invention.

FIG. 10 is a partial cross sectional view in accordance with the conventional waterproof structure of an antenna.

FIG. 11 is a plan view of the conventional waterproof structure of an antenna from which the second case is removed.

FIG. 12 is partial cross sectional view along the line 12-12 of FIG. 10.

FIG. 13 is an explanatory diagram showing a combination of the first and second cases in accordance with the conventional waterproof structure of an antenna.

### DETAILED DESCRIPTION OF THE PREFERRED EMBODIMENTS

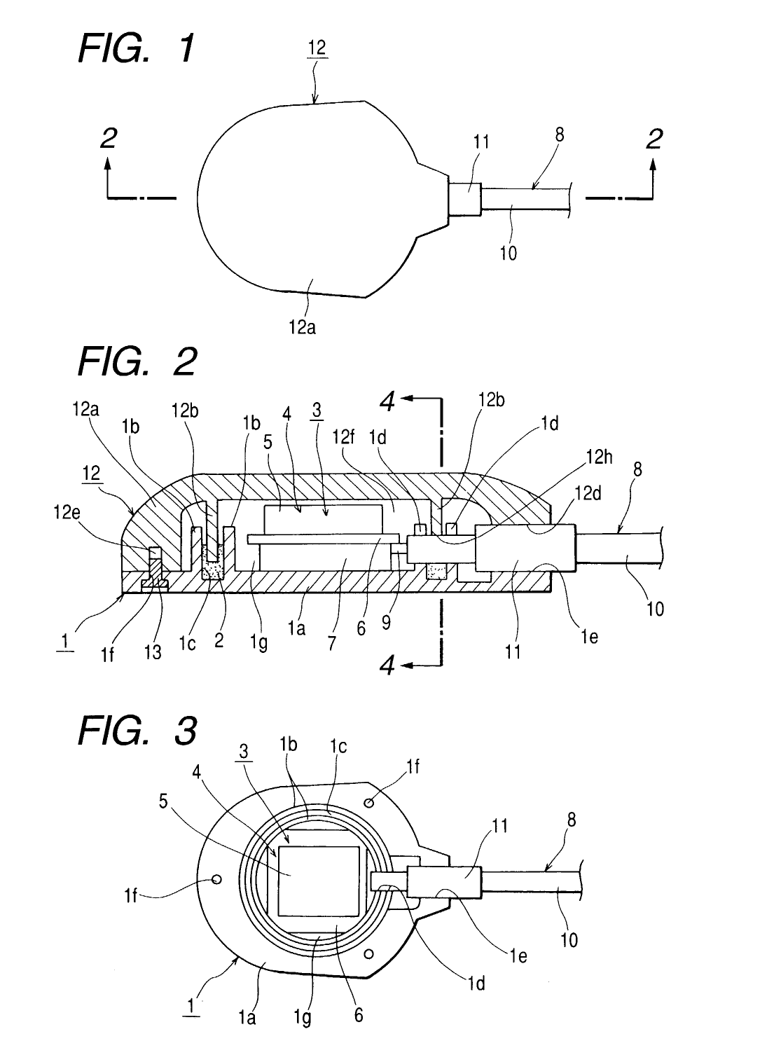

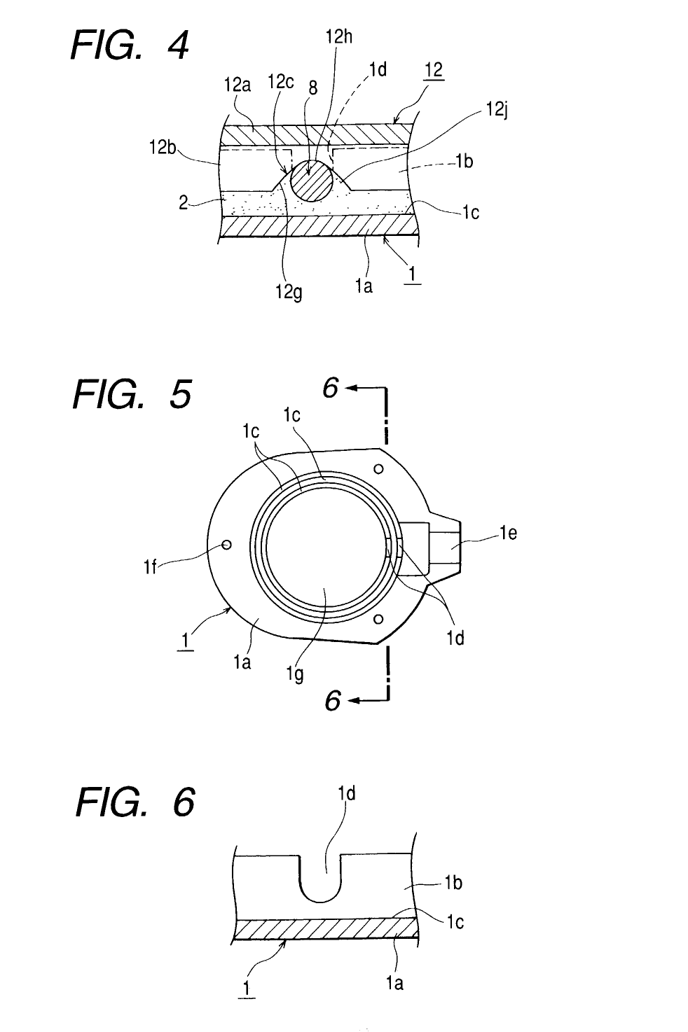

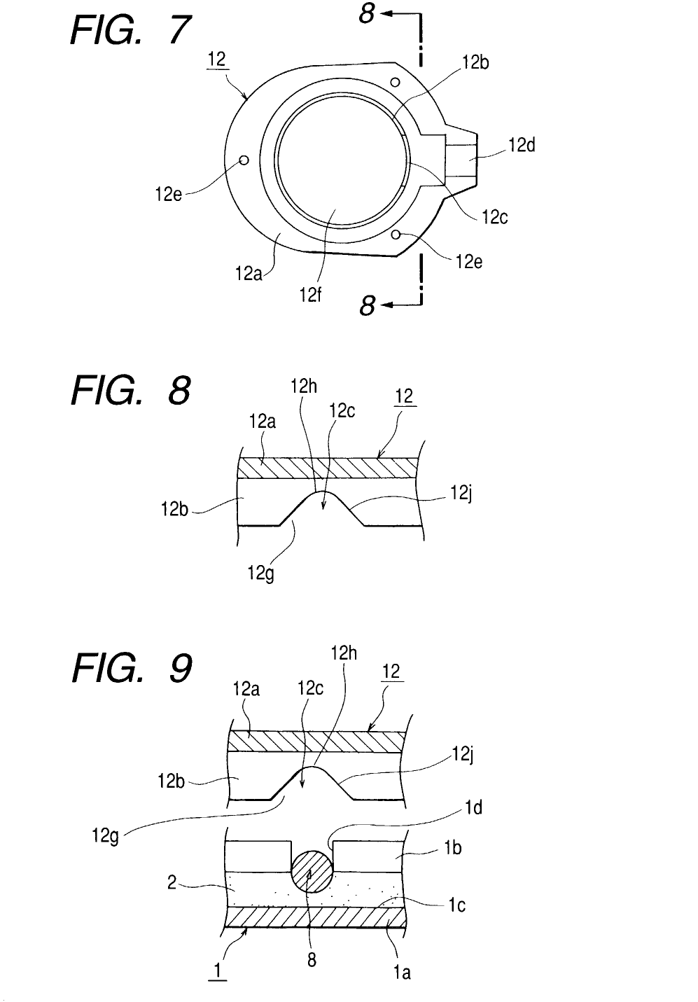

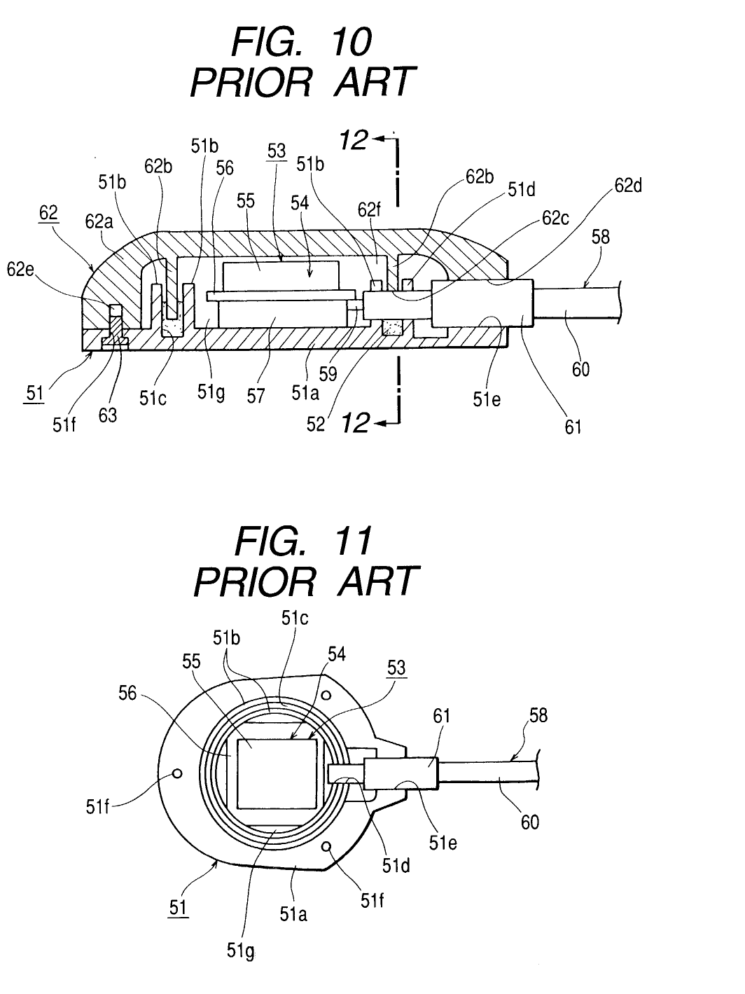

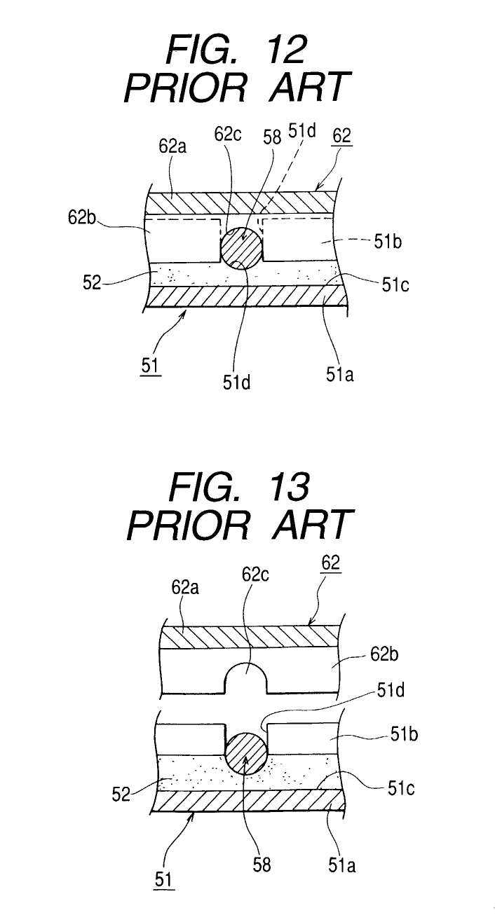

The drawings of the waterproof structure of an antenna of the present invention will be described hereunder. FIG. 1 is a plan view showing the waterproof structure of the antenna of the present invention, FIG. 2 is a partial cross sectional view along the line 2-2 of FIG. 1, FIG. 3 is a plan view showing the structure in accordance with the waterproof structure of the antenna of the present invention from which a second case is removed, FIG. 4 is a partial cross sectional view along the line 4-4 of FIG. 2, FIG. 5 is a plan view showing the first case in accordance with the waterproof structure of the antenna of the present invention, FIG. 6 is a partial cross sectional view along the line 6-6 of FIG. 5, FIG. 7 is a bottom view of a second case in accordance with the waterproof structure of the antenna of the present invention, FIG. 8 is a partial cross sectional view along the line 8-8 of FIG. 7, and FIG. 9 is an explanatory diagram showing a method for combining the first and second cases in accordance with the waterproof structure of the antenna of the present invention.

Next, components of the waterproof structure of the antenna of the present invention will be described with reference to FIG. 1 to FIG. 9 hereinafter. As shown particularly in FIG. 5 and FIG. 6, a first case 1 comprising a mold product consisting of synthetic resin that is served as an under case comprises a flat bottom wall 1a, two circular ring projection walls 1b having different diameters that project upward from the bottom wall 1a, a circular ring recess 1c formed between the two projection walls 1b, and a pair of first notches 1d formed on the two projection walls 1b at the position opposing each other with interposition of the recess 1c.

The first case 1 comprises a circular recess holder 1e formed at the position opposing to the first notch 1d, a plurality of mounting holes 1f formed on the bottom wall 1a, and a recess container 1g formed at the center position of the projection wall 1b.

Furthermore, the adhesive 2 is filled in the recess 1c, and contained in the recess 1c.

An antenna 3 comprises an antenna body 4 and a coaxial cable 8. The antenna body 4 comprises a rectangular parallelepiped antenna 5, a printed board 6 with a printed wiring pattern (not shown in the drawing) that is served for mounting the antenna 5, and a box shield member 7 comprising a metal plate attached to the printed board 6.

A circular cable 8 comprises a sheath 10 consisting of insulating material such as rubber that cover a core wire 9 and a winding 11 consisting of insulating material that is wound partially on the sheath 10. The core wire 9 of the cable 8 is connected to the wiring pattern of the printed board 6 by means of soldering.

In the antenna 3 having the structure as described hereinabove, the antenna body 4 is contained in the container 1g, the cable 8 crosses the recess 1c and is placed in the first notch 1d, and the winding 11 is positioned on the holder 1e.

Furthermore, the width of the first notch 1d is formed so as to be approximately equal to the diameter of the cable 8, and therefore when the cable 8 is inserted into the first notch 1d, the sheath 10 of the cable 8 is inserted with pressure into and tightly pressed on the first notch 1d, and the sheath 10 of the cable 8 is tightly pressed on the bottom of the first notch 1d.

Furthermore, when the cable 8 is inserted with pressure into the first notch 1d, the lower portion of the cable 8 is positioned in the adhesive 2 contained in the recess 1c, and around the bottom half of the cable 8, the space between the first notch 1d and the cable 8 is sealed with the adhesive 2 and the bottom half of the cable 8 is sealed by pressing the sheath 10 of the cable 8 with pressure on the inside wall of the first notch 1d. Thereby, the container 1g is sealed on the lead out side of the cable 8 of the first case 1 side.

As shown particularly in FIG. 7 and FIG. 8, the second case 12 that comprises a mold product consisting of synthetic resin that is served as an upper case comprises a bowl-shaped top wall 12a having the same peripheral configuration as that of the bottom wall 1a, a circular ring projection 12b that projects downward from the top wall 12a, a second notch 12c formed on the projection 12b positioned so as to oppose to the first notch 1d, a circular recess holder 12d formed at the position so as to oppose to the second notch 12c, a plurality of mounting holes 12e formed on the top wall 12a at the positions to the mounting holes 1f, and a recess container 12f positioned at the center of the projection 12b.

Furthermore, the width of the open end top 12g of the second notch 12c formed on the second case 12 is larger than the diameter of the cable 8 and the second notch 12c has an inclination 12j formed so that the width of the second notch 12c becomes wider from the top 12h of the second notch 12 toward the open end top 12g.

The second case 12 is fitted combinedly to the first case 1 so as to cover over the antenna body 4, and a plurality of screws 13 are inserted and screwed from the mounting holes 1f side of the first case 1 into the mounting holes 12e of the second case 12 to thereby combine the first case 1 with the second case 12.

When the first and second cases 1 and 12 are combined, the winding 11 of the sheath 10 of the cable 8 is held with the holders 1e and 12d, the projection 12b is inserted into the recess 1c, and the top end of the projection 12b is embedded into the adhesive 2.

In other words, top end of the projection 12b excepting the portion that is positioned at the second notch 12c is embedded in the adhesive 2.

Furthermore, when these cases 1 and 12 are combined, the cable 8 is positioned in the second notch 12c, the top 12h of the second notch 12c presses the sheath 10 onto the first notch 1d side, the adhesive 2 is filled in the space between the cable 8 and the second notch 12c and the space is sealed with the adhesive 2. Thereby, the container 12f is sealed on the lead out side of the cable 8 of the second case 12 side.

At that time, the adhesive 2 is filled in the space between the top 12h and the cable 8 and the space is sealed.

In other words, on the lead out side of the cable 8 of the first case 1, the bottom half of the cable 8 is inserted with pressure into and tightly pressed on the first notch 1d and the space between the cable 8 and the first notch 1d is sealed with the adhesive 2. On the other hand, on the lead-in side of the cable 8 of the second case 12, the space between the top half of the cable 8 and the second notch 12c is sealed with the adhesive 2. Thereby, the containers 1g and 12f are sealed, and the surrounding of the containers 1g and 12f is sealed by embedding the projection 12b in the adhesive 2. As the result, the antenna body 4 is waterproofed.

Next, a method for combining the first and second cases 1 and 12 will be described with reference to FIG. 9. As shown in FIG. 9, the second case 12 covers the first case 1 so that the second notch 12c is fitted to the cable 8 in the state that the cable 8 has been inserted with pressure into the first notch 1d of the first case 1.

At that time, the top end of the projection 12b of the second case 12 is embedded in the adhesive 2 in the state that the cable 8 is positioned in the second notch 12c.

The surface of the adhesive 2 moves upward concomitantly with embedding of the projection 12b, and the adhesive 2 penetrates from the open end top 12g to the second notch 12c concomitantly with the upward motion of the surface of the adhesive 2 and penetrates to be filled in the whole space between the cable 8 and the second notch 12c. The top 12h of the second notch 12c presses on the sheath 10 of the cable 8, and the sheath 10 is pressed on the bottom of the first notch 1d. Thereby, the combination of the first and second cases 1 and 12 is completed.

When the first and second cases 1 and 12 are combined, because the width of the open end top 12g is larger than the diameter of the cable 8, the adhesive 2 penetrates into the second notch 12c easily, and penetrates into the top 12h securely with aid of the inclination 12j.

Thereby, the space between the top half of the cable 8 and the second notch 12c can be sealed securely with the adhesive 2.

The space between the bottom half of the cable 8 and the first notch 1d is sealed with the adhesive 2 by embedding the bottom half of the cable 8 in the adhesive 2, and the surrounding of the containers 1g and 12f is sealed by embedding the projection 12b in the adhesive 2. As the result, the containers 1g and 12f are sealed securely and the reliable waterproof is obtained.

Furthermore, regardless of variation of the width of the second notch 12c caused when the second case 12 is fabricated or variation of the diameter of the cable 8, the adhesive 2 penetrates into the second notch 12c to seal the space.

Though V-shaped second notch 12c is described in the abovementioned embodiment, another configuration such as U-shape may be employed.

Furthermore, though the case in which the adhesive 2 is interposed between the top 12h and the cable 8 is described, the cable 8 may be pressed strongly on the top 12h.

Furthermore, though the circular ring recess 1d and projection 12b are described, elliptic or polygonal ring recess and projection may be employed.

In the waterproof structure of an antenna of the present invention, the width of the open end top 12g of the second notch 12c provided on the projection 12b of the second case 12 is formed so as to be wider than the diameter 8, the cable 8 that crosses the recess 1c of the first case 1 is placed in the first notch 1d, and the projection 12b that projects into the recess 1c allows the adhesive 2 to penetrate in the second notch 12c and the adhesive 2 seals the space between the cable 8 and the second notch 12c to thereby seal the containers 1g and 12f. As the result, the space between the top half of the cable 8 and the second notch 12c is sealed securely with the adhesive 2, the containers 1g and 12f are sealed securely, and the reliable waterproof is realized.

Furthermore, by employing the structure as described hereinabove, the adhesive 2 penetrates securely in the second notch 12c and the reliable waterproof is realized regardless of variation of the second notch 12c in manufacturing unlike the conventional waterproof in which the adhesive does not penetrate in the notch.

Furthermore, the simple waterproof structure can be realized at high productivity only by forming the width of the open end top 12g of the second notch 12c so as to be larger than the diameter of the cable 8.

Furthermore, because the width of the first notch 1d is formed so as to be approximately equal to the diameter of the cable 8, the bottom half of the cable 8 on the lead-out side of the cable 8 of the first case 1 can be inserted into with pressure and tightly pressed on the first notch 1d, and the adhesive 2 seals the space between the cable 8 and the first notch 1d to thereby realize the reliable waterproof.

Furthermore, the recess 1c is formed in the ring shape, the projection 12b is formed in the ring shape, the top end of the projection 12b excepting a portion positioned at the second notch 12c is embedded in the adhesive 2, and the containers 1g and 12f are sealed. As the result, the surrounding of the containers 1g and 12f is sealed by embedding the projection 12b in the adhesive 2, and the containers 1g and 12f are sealed securely and the reliable waterproof is realized.

Furthermore, the cable 8 is positioned at the top 12h of the second notch 12c, the space between the second notch 12c including the top 12h and the cable 8 is sealed with the adhesive 2, and the space between the top half of the cable 8 and the second notch 12c is sealed securely with the adhesive 2. Thereby, the containers 1g and 12f are sealed more securely, and the reliable waterproof is realized.

Furthermore, because the inclination 12j formed so that the width of the second notch 12c is larger from the top 12h toward the open end top 12g is provided, the adhesive 2 can penetrate into the second notch 12c easily, and the inclination 12j allows the adhesive 2 to penetrate securely into the top 12h.

What is claimed is:

1. A waterproof structure of an antenna provided with first and second cases, an antenna body contained in containers comprising the first and second cases, and a cable that is lead to an outside of the first and second cases, wherein the first case has a recess for containing adhesive and a first notch for placing the cable that is disposed so as to cross the recess, wherein the second case has a projection that projects into the recess and a second notch disposed on the projection that is positioned so as to oppose to the first notch for positioning the cable, wherein a width of an open top end of the second notch is formed so as to be wider than a diameter of the cable, wherein the cable that crosses the recess is placed in the first notch, and wherein the projection that projects into the recess allows the adhesive to penetrate into the second notch to thereby seal a space between the cable and the second notch and to thereby seal the containers.

2. The waterproof structure of an antenna according to claim 1, wherein a width of the first notch is formed so as to be approximately equal to the diameter of the cable.

3. The waterproof structure of an antenna according to claim 1, wherein the recess is formed in ring-shape, wherein the projection is formed in ring-shape, wherein a top end of the projection excepting a portion positioned at the second notch is embedded in the adhesive and wherein the containers are sealed thereby.

4. The waterproof structure of an antenna according to claim 1, wherein the cable is positioned at a top of the second notch, and wherein the space between the second notch including the top and the cable is sealed with the adhesive.

5. The waterproof structure of an antenna according to claim 4, wherein the second notch is provided with an inclination formed so that a width of the second notch becomes wider from the top toward the open end top.
